(19) United States
(12) Patent Application Publication
(10) Pub. No.: US 2002/0190646 A1
(43) Pub. Date: Dec. 19, 2002

(54) Control of leachable mercury in fluorescent lamps

(75) Inventors: Deborah Ann Haitko, Schenectady, NY (US); Stanlee Teresa Buddle, Gloversville, NY (US); David Key Dietrich, Schenectady, NY (US); Donald Franklin Foust, Scotia, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 09/847,198

(22) Filed: May 3, 2001

(51) Int. Cl. H01J 17/20; H01J 61/12

(52) U.S. Cl. 313/571; 313/639

(57) ABSTRACT

A method and apparatus for preventing the formation of leachable mercury in mercury arc vapor discharge lamps is provided which comprises providing in the lamp structure an effective amount of a silver salt, gold salt, or combination thereof.

### BACKGROUND OF THE INVENTION

The present invention relates to a method and apparatus for preventing the formation of leachable mercury in mercury arc vapor discharge lamps.

Mercury arc vapor discharge lamps, otherwise commonly known as fluorescent lamps, are standard lighting means. The mercury arc vapor discharge lamp consists of metallic components such as lead wires, connector pins and end caps. The lead wires and portions of the end cap and connector pins are surrounded by a glass enclosure. The interior of the glass enclosure is typically coated with phosphor. Elemental mercury is added to the mercury arc vapor discharge lamp and typically, the elemental mercury adheres to the phosphor. In certain conditions, it has been found that when elemental mercury comes in contact with the metal components in a lamp such as copper and iron containing lead wires, brass pins, or other associated metallic mount components, the elemental mercury is transformed into a leachable form.

In order to address the growing concern that mercury from disposal of fluorescent lamps might leach into surface and subsurface water, the Environmental Protection Agency has established a maximum concentration level for mercury at 0.2 milligrams of leachable mercury per liter of extract fluid. The concentration level for mercury is generally determined by a standard analysis known as the Toxicity Characteristic Leaching Procedure (TCLP), a well known test procedure implemented in 1990 by the Environmental Protection Agency.

When carrying out the TCLP test, test lamps are pulverized to form lamp waste material similar to that which would result from lamp disposal in land fills or other disposal locations. The ambient conditions in disposal locations may be such as to promote formation of leachable mercury. The TCLP test conditions themselves tend to allow for formation of leachable mercury in amounts greater than the established limit of 0.2 milligrams per liter.

During the disposal of the lamp, and in the TCLP test, the glass enclosure of the lamp is broken. Elemental mercury that is contained in the lamp is then exposed to the metal components in an aqueous environment. Elemental mercury, when exposed to both the metal components and the aqueous environment, is oxidized to leachable mercury. The metal components in the lamp provide the source of oxidizable iron and oxidizable copper that promotes the formation of leachable mercury.

Several techniques have been developed which prevent the formation of mercury that can leach into the environment. The methods currently used are concerned with a method of delivering a chemical agent or metal upon disposal of a lamp or during the TCLP test. For instance, Fowler et al. (U.S. Pat. No. 5,229,686 and U.S. Pat. No. 5,229,687) describe methods that incorporate chemical agents in the lamp in either a glass capsule or the basing cement. These chemical agents include various salts such as bromide anions, chloride anions, iodide anions, iodate anions, periodate anions, and sulfide anions, to name a few. Other chemical agents include powders such as iron powder, copper powder, tin powder, and titanium powder.

In U.S. Pat. No. 5,821,682, which has been assigned to the assignee of the present invention, Foust et al. describe the addition of a mercury antioxidant for superior TCLP test performance. Mercury antioxidants include, for example, ascorbic acid, sodium ascorbate, and sodium gluconate. These materials have been found to reduce or prevent the formation of leachable mercurous and mercuric compounds resulting from the oxidation of elemental mercury. Unfortunately, manufacturing processes typically use a separate dispensing step to introduce the mercury antioxidant.

Generally, any modification of the lamp components is driven by the need to decrease the amount of leachable mercury. Methods and materials are constantly being sought which decrease the leachable mercury values upon performance of the TCLP extraction test.

### SUMMARY OF THE INVENTION

The present invention provides a mercury vapor discharge lamp comprising an effective amount of a silver salt, a gold salt or combination thereof.

The present invention further provides a method for preventing the formation of leachable mercury compounds in mercury vapor discharge lamps comprising providing in the lamp structure an effective amount of a silver salt, a gold salt or combination thereof.

### DETAILED DESCRIPTION

The incorporation of a silver salt, a gold salt, or combination thereof has been found to have a significant effect on preventing mercury compounds from leaching during the TCLP test. Accordingly, the formation and dissolution of soluble ferric and cuprous ions from the mercury vapor arc discharge lamp components is diminished or prevented resulting in reduction or prevention of leachable mercury compounds.

Lead wires are typically made of iron or copper and connector pins are typically made of brass. The lead wires and connectors pins are the source of elemental iron (Fe⁰) and copper (Cu⁰) which is oxidized in the presence of oxygen and an aqueous environment to ferric (Fe⁺³) and cuprous (Cu⁺¹) ions. Ferric and cuprous ions can then dissolve in aqueous solution. The presence of ferric and cuprous compounds has been found to lead to the formation of leachable mercury.

“Leachable mercury” as used herein refers to elemental mercury (Hg⁰) which has been oxidized. Oxidized mercury reacts with oxygen to form compounds such as mercuric oxide (HgO). Once the lamp has been broken and the elemental mercury can oxidize to leachable mercury, the leachable mercury can be carried via groundwater, rivers and streams.

Suitable silver salts include, for example, silver carbonate, silver halides, silver oxide, silver sulfide, silver acetate, or combinations thereof. Suitable gold salts, include, for example, gold carbonate, gold halide, gold oxide, gold sulfide, gold acetate, or combinations thereof. Typically, silver carbonate is used in the present invention.

To prevent the spurious formation of leachable mercury upon disposal of mercury vapor discharge lamps and to improve the reliability of the TCLP test, an effective amount of a silver salt, gold salt, or combination thereof is incorporated in the lamp structure, for example within the glass envelope exterior to the plasma discharge, in an end-cap, or in the base of the lamp. An effective amount of the silver salt, gold salt, or combination thereof is that amount which will substantially prevent the interaction of elemental mercury with ferric and cuprous compounds that can oxidize elemental mercury to a soluble form. In general, an effective amount of the silver salt, gold salt, or combination thereof will be enough for the TCLP test results to show the presence of less than about 0.2 parts per million of leachable mercury per lamp. Typically, the silver salt, gold salt, or combination thereof is present in a range between about 0.1 milligrams and about 10 grams per=lamp, and more typically, in a range between about 10 milligrams and about 30 milligrams per lamp.

The silver salt, gold salt, or combination thereof is typically incorporated in the basing cement of the lamp that holds the aluminum cap to the leaded glass portion of the end of the lamp. The basing cement generally comprises about 80 weight % marble flour (limestone-CaO), and the balance shellac a phenolic resin binder, a solvent for blending, and a dye used to color the cement. The cement is dispensed through a feeder into the base and heated to cure once assembled with the lamp. The curing drives off the solvent and solidifies the cement. The silver salt, gold salt, or combination thereof is blended with the cement components and incorporated into a lamp manually or by automated manufacturing equipment. The silver salt, gold salt, or combination thereof is released only when the lamp is destroyed or crushed in preparation for TCLP testing. In this method, the silver salt, gold salt, or combination thereof is always exterior to the positive column of the lamp. The positive column is a typically under vacuum and is a portion of the lamp that includes the interior of the stem press (inner leads and cathode) which is filled with phosphor and inert gases that fill the lamp. Inert gases that fill the lamp typically include argon and krypton. By incorporating the silver carbonate, gold carbonate, or combination thereof within the basin cement of the end cap, no separate dispensing step to introduce the silver salt, gold salt, or combination thereof is necessary.

The silver salt, gold salt, or combination thereof can also be formulated into a thermally curable adhesive or binding composition which is soluble in acidic aqueous solutions. Such compositions generally include an inert filler material, a binder such a polyvinymethacrylate, and a processing solvent such as denatured alcohol. The alcohol will evaporate and the composition will cure when the basing cement is cured. These ingredients are similar to the usual components of basing cements used to secure the glass envelope to the aluminum base or end cap. Gums and gelatins have also been used as such adhesives and binders. The nature of the gums and gelatins is that they adhere to surfaces when heated. The composition containing the antioxidant material can be placed on the inner surface of the aluminum end cap as a ring or discrete button. When the lamp is crushed and exposed to an aqueous environment or placed in the TCLP solution, the aqueous soluble binder allows the silver salt, gold salt, or combination thereof to be released quickly.

Typical fillers include marble flour (calcium oxide). The binder material can be shellac, rosin synthetic resins such as phenolic resin. Processing solvents are generally lower alcohols such as ethyl, propyl, butyl, or amyl alcohol.

The silver salt, gold salt, or combination thereof can also be incorporated in the lamp by encapsulation of the material in a glass capsule that can be placed either in the base of the lamp between the aluminum cap and flare of leaded glass, or placed within the positive column of the lamp. Since the silver salt, gold salt, or combination thereof is enclosed in a glass capsule, it could be present in the inside of the positive column of the lamp without affecting lamp function.

The invention is illustrated by testing of mercury vapor arc discharge lamps via the TCLP test in which silver carbonate was added to the lamp components. These examples are to be regarded as non-limiting.

All TCLP test data was obtained by the test procedure prescribed on pages 26987-26998, volume 55, number 126 of Jun. 29, 1990 issue of the Federal Register.

Briefly, lamps being tested with the TCLP test were pulverized into particulate form having the prescribed particle size which is capable of passing through a ⅜ inch sieve. The test material was then extracted with a sodium acetate-acetic acid buffer at a pH of about 4.93.

Varying amounts of silver carbonate were added to the TCLP test to determine the effectiveness of the silver salt on reducing the amount of leachable mercury formed during the TCLP test. The data in Table 1 shows that levels as low as 10 milligrams of silver carbonate per lamp reduced leachable mercury to below the regulatory limit of 0.2 parts per million per lamp when either a F32T8SCSP35 lamp or F40T12 Cool White WattMiser lamp (both available from GE Lighting) was mercury dosed at 20 milligrams per lamp. One of the most important advantages of using silver carbonate is the fact that the milligram quantities of silver carbonate required can be easily incorporated within the basin cement of the end cap. No separate steps were required to add silver carbonate to the basing cement. TCLP test results using silver carbonate within the basing cement are shown in FIG. 1.

Undosed F32T8SCSP35 lamps (hereinafter referred to as “F32”) and F40T12 (hereinafter referred to as “F40”) Cool White WattMiser lamps were used for screening the additives. Technical grade and 99% silver carbonate (Ag₂CO₃) were purchased from Aldrich Chemicals and were not purified prior to use. Standard TCLP protocol was followed with modifications for lamp testing made according to the Scientific Applications International Laboratory's study of fluorescent lamp/TCLP testing commissioned by the Environmental Protection Agency as described in “Analytical Results of Mercury in Fluorescent Lamps,” by SAIC, EPA Contract No. 68-WO-0027, May 15, 1992. Results of various amounts of silver carbonate (Ag₂CO₃) added to the 20 milligram mercury (Hg) dosed F40 and F32 lamps can be seen in Table 1.

TABLE 1

| | Amount Ag₂CO₃ | Leachable Hg for | Leachable Hg for F32 |
|---|---|---|---|
| Sample # | added (mg) | F40 (ppb) | (ppb) |
| 1 | 50 | <25 | |
| 2 | 10 | 60 | |
| 3 | 5 | 70 | |
| 4 | 50 | | <25 |
| 5 | 20 | | <25 |
| 6 | 10 | | 33 |
| 7 | 5 | | 40 |
| 8 | 0 | 441 | |
| 9 | 0 | | 512 |

As seen in Table 1, 5 milligrams of silver carbonate reduced the amount of leachable mercury in the F40 and F32 lamps by more than one-sixth and one-twelfth respectively compared to when silver carbonate was not added to the lamps. In addition, 50 milligrams of silver carbonate effectively reduced the amount of leachable mercury for both lamps to less than 25 parts per billion (ppb) per lamp.

While embodiments have been shown and described, various modifications and substitutions may be made thereto without departing from the spirit and the scope of the invention. Accordingly, it is to be understood that the present invention has been described by way of illustration and not limitation.

What is claimed is:

1. A mercury vapor discharge lamp comprising an effective amount of a silver salt, a gold salt or combination thereof.

2. The mercury vapor discharge lamp of claim 1, wherein said silver salt comprises silver carbonate, silver halide, silver oxide, silver sulfide, silver acetate, or combinations thereof.

3. The mercury vapor discharge lamp of claim 2, wherein said silver salt is silver carbonate.

4. The mercury vapor discharge lamp of claim 1, wherein said gold salt comprises gold carbonate, gold halide, gold oxide, gold sulfide, gold acetate, or combinations thereof.

5. The mercury vapor discharge lamp of claim 1, wherein said silver salt, gold salt, or combination thereof is present in a range between about 0.1 milligrams and about 10 grams per lamp.

6. The mercury vapor discharge lamp of claim 5, wherein said silver salt, gold salt, or combination thereof is present in a range between about 10 milligrams and about 30 milligrams per lamp.

7. The mercury vapor discharge lamp of claim 1, wherein said silver salt, gold salt, or combination thereof substantially prevents the interaction of elemental mercury with ferric and cupric compounds which oxidize elemental mercury to a soluble form.

8. A mercury vapor discharge lamp comprising an amount of silver carbonate in a range between about 10 milligrams and about 30 milligrams per lamp to substantially prevent the interaction of elemental mercury with ferric and cupric compounds which oxidize elemental mercury to a soluble form.

9. A method for preventing the formation of leachable mercury compounds in mercury vapor discharge lamps comprising providing in the lamp structure an effective amount of a silver salt, gold salt, or combination thereof.

10. The method of claim 9, wherein said silver salt comprises silver carbonate, silver chloride, silver oxide, silver sulfide, silver acetate, or combinations thereof.

11. The method of claim 10, wherein said silver salt comprises silver carbonate.

12. The method of claim 9, wherein said gold salt comprises gold carbonate, gold halide, gold oxide, gold sulfide, gold acetate, or combinations thereof.

13. The method of claim 9, wherein said silver salt, gold salt, or combination thereof is present in a range between about 0.1 milligrams and about 10 grams per lamp.

14. The method of claim 13, wherein said silver salt, gold salt, or combination thereof is present in a range between about 10 milligrams and about 30 milligrams per lamp.

15. The method of claim 9, wherein said silver salt, gold salt, or combination thereof substantially prevents the interaction of elemental mercury with ferric and cupric compounds which oxidize elemental mercury to a soluble form.

16. A method for preventing the formation of leachable mercury compounds in mercury vapor discharge lamps comprising providing an amount of silver carbonate in a range between about 10 milligrams and about 30 milligrams per lamp to substantially prevent the formation of ferric and cupric compounds which oxidize elemental mercury to a soluble form.
